(19) United States
(12) Patent Application Publication
(10) Pub. No.: US 2011/0061470 A1
(43) Pub. Date: Mar. 17, 2011

(54) Pitot tube design for incompressible fluids with viscosity and turbulence

(76) Inventor: Harold James Willard, JR., Washington, DC (US)

(21) Appl. No.: 12/923,102

(22) Filed: Sep. 2, 2010

Related U.S. Application Data
(60) Provisional application No. 61/272,342, filed on Sep. 15, 2009.

(51) Int. Cl. G01F 1/46

(52) U.S. Cl. 73/861.65

(57) ABSTRACT

A Pitot tube design and methodology are presented for use with incompressible fluids for a full range of viscosity and including the effect of turbulence on the flow characteristics and device response. Current practice assumes an inviscid fluid or a fluid having an unrealistically high viscosity (Poiseuille fluid) in the design and analysis of devices using Pitot tubes. A new Two-Fluid Theory, supported by experimental data, is used for the design analysis.

### REFERENCE TO PRIOR APPLICATION

Provisional application No. 61/272,342, filed Sep. 15, 2009

### REFERENCES CITED

(1) The Handbook of Fluid Dynamics, Richard W. Johnson, Ed, CRC Press, 1998, Section 33.3.
(2) Hunsaker, J. C. and Rightmire, B. C., Engineering Applications of Fluid Mechanics, McGraw-Hill, New York, 1947, Chapter VIII.

### U.S. PATENT DOCUMENTS

(1) U.S. Pat. No. 7,478,565 B2 1/2009, Young 73/861.65
(2) U.S. Pat. No. 6,534,830 B2 7/2003 Long 73/54.09

### BACKGROUND OF THE INVENTION

One of the most important devices for measuring flow characteristics is the Pitot tube, shown schematically in FIG. 1 in its application to an external flow field. Such devices, in various forms, are used routinely for flows inside tubes and in channels, for gases and liquids. A very important application of Pitot tubes is the measurement of the speed of aircraft relative to wind speed.

However, the analytical methodology heretofore used to assess flow characteristics such as pressure and velocity from Pitot tube data has been based upon the assumption that the fluid is either inviscid, which is strictly true only for superfluid helium, or for a fluid with an unrealistically high viscosity (Poiseuille fluid) (Ref. 1). Real fluids of finite viscosities can exhibit fluid flow behavior which differs greatly from that predicted for these extremes. The present invention corrects these deficiencies.

There are over 1500 references to Pitot tubes in the Patent Office data bank. As examples of current practice, two recent patents are considered. In Long (U.S. Pat. No. 6,584,830 B2 Jul. 1, 2003), a device is presented to measure the viscosity of a flowing fluid used in processing chemicals used in the photography industry. The inventor uses the equation for a Poiseuille fluid (Eqn. 5) and also that for an inviscid fluid (Eqn. 6) in the same analysis. The resulting equation (Eqn. 7) used to justify the device combines both equations and is clearly erroneous. The measured results show: “processed signal” as a function of inlet pressure (FIGS. 3,4,5). (Presumably FIG. 3 should be labelled Differential Pitot Pressure, rather than “Pilot Pressure (psi) and Flow Rate should be in units of ml/s(?) in FIGS. 4 & 5, rather than psi.) It seems likely that the sensitivity of the device to viscosity exhibited is due to other causes (vortex behavior?) and if well understood might lead to an enhancement of its performance.

In Young (U.S. Pat. No. 7,478,565 B2 Jan. 20, 2009), an apparatus is presented for fluid flow rate and density measurements. Equation 27 uses the relationship for an inviscid fluid in the derivation of flow rate, Eqns. 29 and 30. However, the device is intended to be used with real liquids and gases. The kinematic viscosity of air, for example, is comparable to that of water and both exhibit very significant deviations from inviscid fluid behavior. Again, an analysis based on real fluid behavior might yield improve performance.

The basic equations governing fluid flow are non-linear and a satisfactory closed-form solution for the velocity distribution has not been developed prior to this work for a full range of viscosities. In the extreme limits for inviscid and highly viscous flow, solutions are well-known. Bernouilli's equation (1738) adequately describes inviscid flow and is often applied to the flow of water, a fluid of low, but not zero, viscosity for engineering purposes. At the opposite extreme, the Poiseuille equation (1839-46) is used to describe flow in which viscous rather than inertial forces completely dominate the behavior.

In the intermediate range between inviscid and highly viscous behavior, an engineering approximation in the form of a friction factor, introduced circa 1850, is used to account for the pressure drop in pipes due to viscosity and surface roughness, excluding entrance effects, which, for relatively low length to diameter ratios can dominate the actual flow behavior. The friction factor approximation is still in use and may need improvement to adequately solve the complex technical problems now challenging humanity in energy supply, space programs, food processing facilities, biomedical research and applications, and a myriad of other applications.

Additionally, an analytical theory applicable to a full range of viscosity is needed to account for the change in fluid behavior due to changes in fluid viscosities occurring in operating systems. Lubricating oils become more viscous as wear and combustion products accumulate, radiation damage could affect the viscosity of fluids used in long-term space missions, and the accumulation of cholesterol and triglycerides in human blood, and presumably in the blood of other animals, as well, can result in an increase in viscosity leading to elevated blood pressure, a major health problem world-wide.

Thus, the successful application of this methodology to the simplest of flow-measuring devices, the Pitot tube, can demonstrate its applicability to a whole host of other practical and research applications of immense benefit to humanity.

### BRIEF SUMMARY OF THE INVENTION

This invention presents a Pitot tube design and methodology for determining the flow characteristics of incompressible fluids which includes the effects of viscosity and turbulence in the analysis. Pitot tubes and other flow measuring devices based on differential pressure-velocity relationships assume either an inviscid fluid or a fluid having an unrealistically high viscosity (Poiseuille fluid) in the analyses of their performance. Furthermore, the effect of turbulence on flow behavior is not considered, which can greatly affect flow rates.

In the present invention, a methodology, called the Two-Fluid Theory, is developed and supported by experimental data, which treats a real fluid as being composed of a mixture of two ideal fluids: an inviscid fluid and a fluid having a very high viscosity (a Poiseuille fluid). The resulting expression for flow velocity is applicable to a real fluid of any viscosity and to tubes of any ratio of length to diameter, including entrance effects. Additionally, the effect of turbulence is included in the analysis.

### BRIEF DESCRIPTION OF THE FIGURES

FIG. 1. Schematic of pitot tube, showing entrance length 4.

FIG. 2. Measured Saybolt viscometer results (Ref. 2): Time to drain 60 cc of fluid through a capillary tube as a function of kinematic viscosity; calculations from Two-Fluid Theory with and without turbulence.

FIG. 3. Measured fluid height in a tank draining through a smooth tube of diameter 0.35 cm and length 16.7 cm as a function of time for water and olive oil at approximately room temperature. Curves are Two-Fluid Theory calculations with and without turbulence and for water as an inviscid fluid.

FIG. 4. Calculated fluid velocities from Two-Fluid Theory and from using inviscid fluid expression for air at 12,000M and at standard temperature and pressure as a function of differential Pitot tube pressure (L=10 cm; Lₑ=1 cm; a=0.25 cm).

FIG. 5. Calculated fluid velocities from Two-Fluid Theory for water and for a fluid having a density of water and a viscosity four times that of water as a function of differential Pitot tube pressure, at about room temperature. Also shown is the velocity calculated from the inviscid fluid expression (L=10 cm; Lₑ=1 cm; a=0.25 cm).

### DETAILED DESCRIPTION OF THE INVENTION

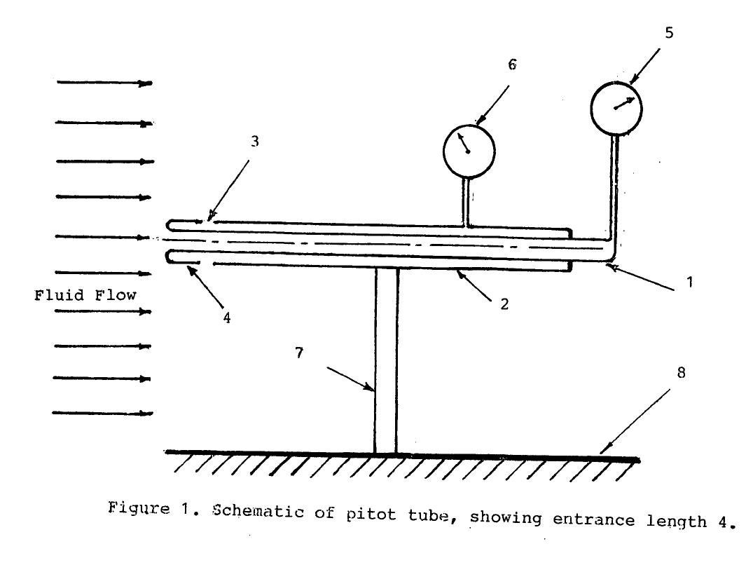

FIG. 1 is a schematic of a Pitot tube conforming to this invention, which is to be manufactured in accordance with current practice from a smooth tube of steel, titanium or other metal or material selected for the environment in which the device is to be employed. The schematic shows the Pitot tube affixed to a support 7 attached to a surface 8, which could be the surface of an aircraft, land or water vehicle, or inside a pipe or conduit.

The fluid direction is shown parallel to the axis of the tube. If the fluid impinges at an angle θ, the component of the velocity along the tube axis, V cos θ, is to be applied in the analysis in lieu of V, in accordance with current practice.

The length of support 7 is such that disturbance of the flow due to the proximity of the wall is not significant.

In the discussion, the following definitions apply:
V is the fluid field velocity (cm/s);
V(r,z) is the velocity of the fluid inside the tube (cm/s);
d is the inner diameter of the tube (cm);
L is the active length of the tube, from the openings at 3 to the elbow (cm);
Lₑ is the entrance length selected to ensure that a Poiseuille distribution for the viscous component of the fluid has been fully developed (cm);
z is distance in the direction of flow inside the tube (cm);
ρ is density of the fluid (gms/cm³);
μ is dynamic viscosity (dynes/cm³);
ν is kinematic viscosity (cm²/s);
P_{S} is pressure (dynes/cm²); (static; gauge 6);
P_{O} is stagnation pressure at the elbow (dynes/cm²) (gauge 5);
ΔP is pressure increase in the pipe, P_{O}−P_{S}.

The equation governing the steady-state flow of fluids in pipes in the absence of work or heat is attributed to Euler (1752-55), Navier(1822), and Stokes(1845,51):

$$ρ \cdot V ( r , z ) \cdot \frac{δ V ( r , z )}{δ z} = - \frac{δ P}{δz} + \frac{μ}{r} \frac{δ}{δ r} \{ \frac{r δ V ( r , z )}{δ r} \} + \frac{{δ}^{2} V ( r , z )}{δ {z}^{2}} \qquad ( 1 )$$

Although an exact closed-form solution to Equation 1 is not forthcoming, an approximate solution is given by

$$V ( r , z ) = \frac{α ( z ) \cdot β ( r , z )}{α ( z ) + β ( r , z )} \qquad ( 2 )$$

in which α(z), the solution for μ=0, is

$$α ( z ) = \sqrt{\frac{2 \cdot Δ P}{ρ} ( \frac{z}{L} )} \qquad ( 3 )$$

An approximate solution of Eq:n. 1 in the limit of very high viscosity, neglecting the term

$$ρ \cdot V ( r , z ) \cdot \frac{δ V ( r , z )}{δ z} ,$$

is given by

$$β ( r , z ) = {β}_{m} ( z ) ( 1 - \frac{{r}^{2}}{{a}^{2}} ) , \qquad ( 4 )$$

in which βₘ(z) is the Poiseuille velocity on the centerline, given by

$${β}_{m} ( z ) = \frac{Δ P \cdot {a}^{2}}{4 μ \cdot L} ( 1 - {{e}^{-}}^{\frac{2 z}{a}} ) . \qquad ( 5 )$$

The z dependence is strictly true only on the centerline, but represents the worst case condition. The bracketed term accounts for the build-up of the Poiseuille velocity to its steady-state value and represents an entrance effect to be included in the design.

The average velocity over the cross section of the pipe at distance z is

$$\begin{matrix}\overline{∇} ( z ) = \frac{1}{π {a}^{2}} {\int }_{0}^{a} 2 π r \cdot V ( r , z ) \cdot d r \\ = α ( z ) \cdot \{ 1 - \frac{ln ( 1 + {β}_{m} ( z ) / α ( z )}{{β}_{m} ( z ) / α ( z )} \}\end{matrix} \qquad ( 6 )$$

For this work, z=L and 2 L/a=80, rendering the exponential term in Equation 5 negligible. In the limit of zero viscosity, V̅→α. For very high viscosity, V̅→βₘ/2.

Equation 6 applies to flow in the absence of turbulence. The Navier-Stokes equation, Equation 1, is clearly inadequate to account for turbulence. Additional forces exist internal to the system which lead to instability and loss of energy from the linear flow field. Experimental observations of turbulence reveal the following basic characteristics: (1) Turbulence exists because of viscosity, but is also suppressed by viscosity; (2) Turbulence results in a loss of energy in the linear flow field which appears to saturate: i.e. the flow is not choked off nor does turbulence die away over long distances after once established; (3) turbulence does not persist when the Reynolds number (V·2a/ν) is reduced to less than about 2000, but does not necessarily initiate when Rₑ is raised to 2000. Under quiescent conditions, it may be delayed until much higher Reynolds numbers are attained; (5) Highly viscous flow is completely free of turbulence and is largely unaffected by surface roughness and other irregularities in pipes.

From these considerations, a reasonable representation for turbulence is to assume that in the turbulent state, the same function for velocity applies as in the normal state, but with the inviscid fluid component only modified. Thus,

$$\begin{matrix}{V}_{t} ( r , \overline{z} ) = \frac{{α}_{t} ( r , z ) \cdot {β}_{n} ( z )}{{α}_{t} ( r , z ) \cdot {β}_{n} ( z )} \\ and & ( 7 ) \\ {\overline{V}}_{t} ( z ) = {α}_{t} ( z ) \cdot \{ 1 - \frac{Ln ( 1 + {β}_{m} ( z ) / {α}_{t} ( z ) )}{{β}_{m} ( z ) / {α}_{t} ( z )} \} & ( 8 )\end{matrix}$$

in which the subscript t refers to the turbulent state for the inviscid velocity.

From energy considerations, a reasonable representation for the turbulent inviscid velocity is, at z=L,

$${α}_{t} = α \cdot {\{ 1 - η \cdot {( \frac{1 + {β}_{m} / α}{{β}_{m} / α} )}^{2} \cdot {e}^{- j / {β}_{m} / α} \}}^{.5} \qquad ( 9 )$$

in which η and τ are constants determined from experiment. For a smooth pipe, τ=2 and η, which accounts for turbulence entrance effects, is given by

(10η(L/2a)=(1.0−0.4e^{-L/10a}−0.6e^{-L/320a})

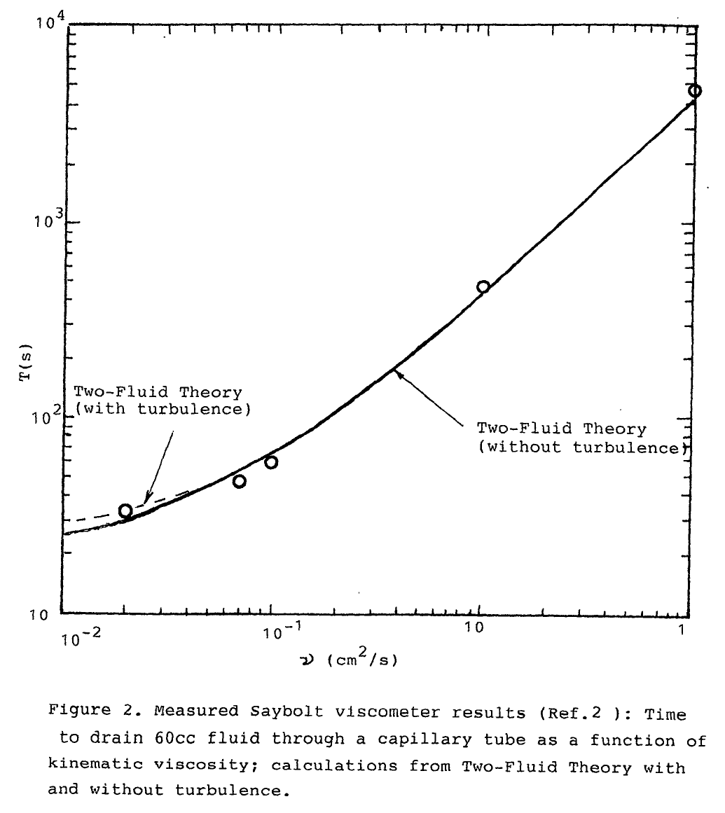

FIG. 2 presents the results of the 2-F Theory applied to Saybolt viscometer data (Reference 2), demonstrating that the methodology is valid for a full range of viscosity. In the Saybolt tests, the time required for 60 cc of fluid of various viscosities to drain through a capillary tube is measured.

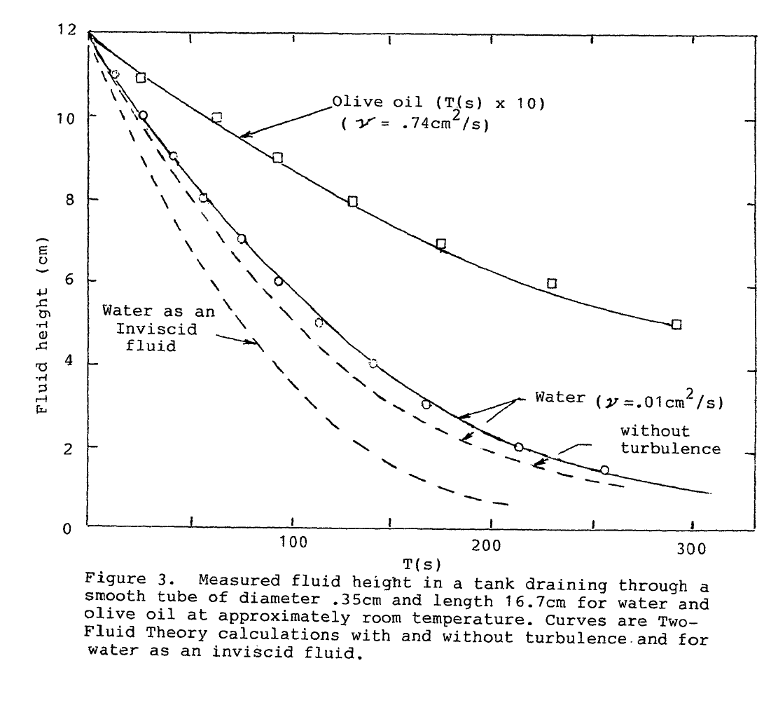

FIG. 3 presents the application of the 2-F Theory to the flow of water and olive oil through a smooth tube of 0.35 cm diameter and 16.7 cm length. Height of the fluids in a tank measured as a function of time are well represented by the theory. Olive oil (ν=0.74 cm²/s) is highly viscous, exhibiting Poiseuille behavior under these conditions. Water (ν=0.01 cm²/s) is more nearly inviscid, but still retains significant viscous effects. Additionally, the effect of turbulence is evident (Reynold's number 2700 at maximum height). Calculations for water as an inviscid fluid, and without turbulence, are also shown, demonstrating that both make significant contributions to the flow behavior. These results illustrate the validity of the 2-F Theory for extremes of viscosity and for turbulence. Air is essentially incompressible for these conditions.

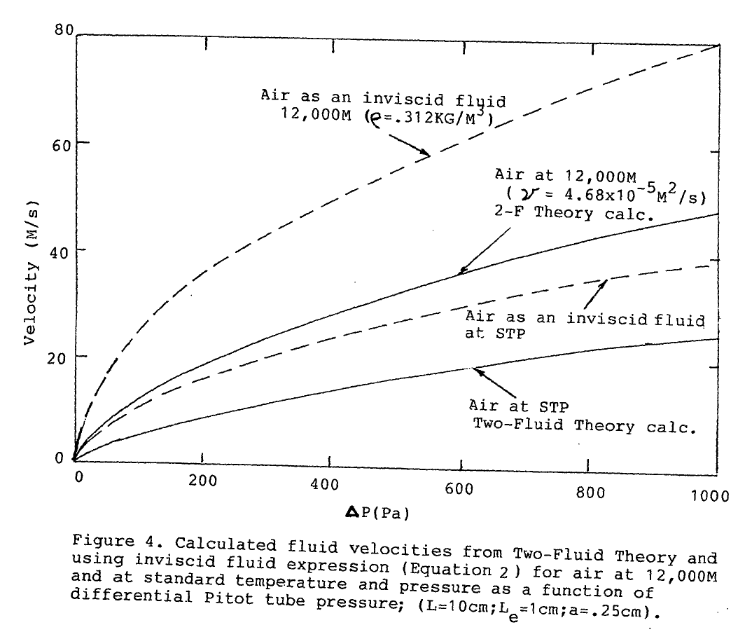

FIG. 4 shows calculated velocities expected for a Pitot tube of FIG. 1 with L=10 cm, Lₑ=1 cm and a=0.25 cm, for air at 12,000M and at standard temperature and pressure (STP). For comparison, the velocities as a function of differential pressure assuming air is an inviscid fluid are also shown. At a differential pressure of 400 Pa, the velocity predicted from Eqn.2 for an inviscid fluid is 1.7 times that for real air at 12000M and 1.6 times that for real air at STP.

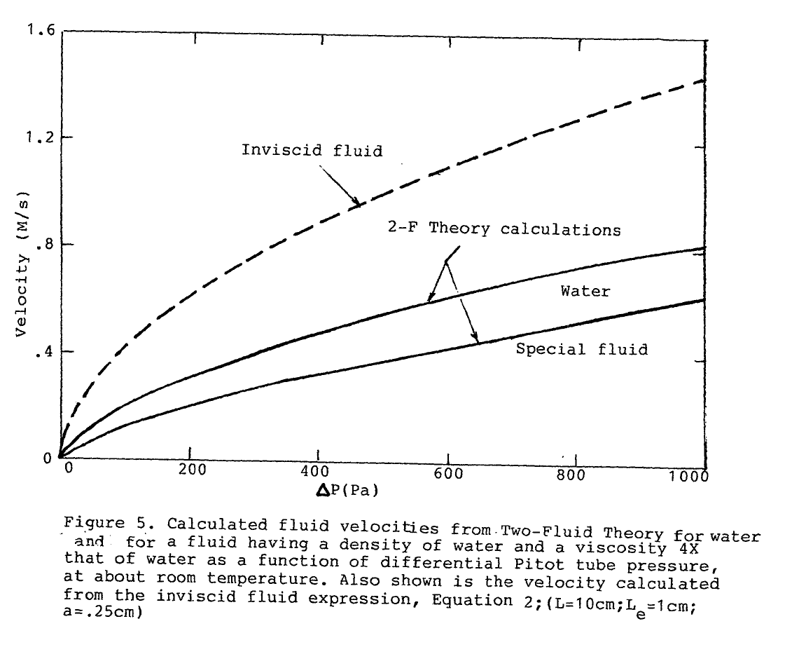

FIG. 5 presents similar calculations for water at STP and for a special fluid having a density of water and a viscosity four times that of water, at STP. For water, the ratio of inviscid flow velocity to real flow velocity is 1.8. For the special fluid, it is 2.5.

Clearly, using the inviscid expression for real fluids is unacceptable for a reasonable representation of real flow behavior.

The preceding discussion has been presented to illustrate the principles of this invention and is not intended to limit the applicability of the invention to this particular Pitot tube design. There are various design configurations in use for Pitot tubes. This methodology applies to those, as well, and also to such devices as Venturi tubes, which are also used to measure flow characteristics using the principles developed in the theory.

I claim that:

1) this invention provides a Pitot tube design and methodology for use with incompressible fluids for a full range of viscosity;

2) this invention provides a Pitot tube design and methodology for use with incompressible fluids which include the effect of turbulence on the flow characteristics and device response;

3) this invention provides a design and methodology for use with other flow measurement devices, such as Venturi tubes, for use with incompressible fluids, which is applicable to a full range of fluid viscosity and which include the effect of turbulence on the flow characteristics and device response.
